(19) United States
(12) Patent Application Publication
(10) Pub. No.: US 2024/0139876 A1
(43) Pub. Date: May 2, 2024

(54) METHOD FOR PRODUCING POWER STORAGE DEVICE

(71) Applicant: Prime Planet Energy & Solutions, Inc., Tokyo (JP)

(72) Inventor: Haruhiko YAMAMOTO, Nisshin-shi (JP)

(21) Appl. No.: 18/460,595

(22) Filed: Sep. 4, 2023

(30) Foreign Application Priority Data
Oct. 27, 2022 (JP) 2022-172566

(51) Int. Cl. B23K 26/24; H01M 50/103; H01M 50/15; H01M 50/169

(52) U.S. Cl. CPC B23K 26/24; H01M 50/103; H01M 50/15; H01M 50/169

(57) ABSTRACT

In a method for producing a power storage device, a welding process includes welding a first long-side part through scanning of a laser beam from a second short-side part side to a first short-side part side of the first long-side part; and welding a second long-side part through scanning of the laser beam from a first short-side part side to a second short-side part side of the second long-side part. In welding the first long-side part, a first gas stream is generated, passing above the first long-side part from the first short-side part side to the second short-side part side. In welding the second long-side part, a second gas stream is generated, passing above the second long-side part from the second short-side part side to the first short-side part side.

### CROSS-REFERENCE TO RELATED APPLICATIONS

This application is based upon and claims the benefit of priority to Japanese Patent Application No. 2022-172566 filed on Oct. 27, 2022, the entire contents of which are incorporated herein by reference.

### BACKGROUND

### Technical Field

The present disclosure relates to a method for producing a power storage device.

### Related Art

Japanese unexamined patent application publication No. 2015-107515 (JP2015-107515A) discloses a power storage device that includes a case including a rectangular opening and a rectangular sealing plate closing the opening. In this power storage device, an opening wall portion surrounding the opening of the case and an outer periphery edge portion of the sealing plate are welded with each other over their entire circumference.

The above-described power storage device is produced in the following manner. First, in a closing process, the sealing plate is inserted in the opening of the case to close the opening of the case with the sealing plate. Next, in a welding process, while the opening of the case is closed with the sealing plate having an outer surface facing upward, and a contact portion where the outer periphery edge portion of the sealing plate and the opening wall portion of the case are in contact with each other, which will be referred to as a to-be-welded portion, is irradiated with a laser beam from above the sealing plate, the to-be-welded portion is laser-welded over the entire circumference thereof in a circumferential direction. Such a to-be-welded portion has a rectangular ring shape in a plan view, and includes a first long-side part and a second long-side part, which are parallel to each other, and a first short-side part and a second short-side part, which are parallel to each other.

### SUMMARY

### Technical Problems

Meanwhile, in the above-described welding process, fumes are generated from the to-be-welded portion irradiated with the laser beam. Here, fumes are dust floating in a space, i.e., in air, specifically, fine metal particles (metal dust) caused by cooling metal vapor generated from the to-be-welded portion due to welding heat. When fumes are present in an optical path of the laser beam, the laser beam collides with the fumes and is diffused thereby, which may cause deterioration of energy density of the laser beam with which the to-be-welded portion is irradiated. Accordingly, weld defect occurs in some cases.

Therefore, in the welding process in JP2015-107515A, air is exhausted, through suction ports of exhaust nozzles disposed along the outside of the to-be-welded portion over the entire circumference, from the center side of the sealing plate toward the outside of the sealing plate when seen from a direction perpendicular to a flat surface of the sealing plate. Furthermore, inert gas is supplied, through air supply ports of air supply nozzles disposed below the exhaust nozzles along the outside of the to-be-welded portion over the entire circumference, from the outside of the sealing plate toward the center of the sealing plate when seen from the direction perpendicular to the flat surface of the sealing plate. In this manner, the generated fumes are caused to travel outward from the center side of the sealing plate.

However, with the method described in JP2015-107515A, it is difficult to remove the generated fumes from the optical path of the laser beam. Thus, it is difficult to reduce weld defect caused when the laser beam collides with fumes. Therefore, there has been demanded a method capable of effectively reducing weld defect between the case and the sealing plate by reducing weld defect attributed to fumes. In particular, there is a need for a method to reduce weld defect attributed to fumes in the first long-side part and the second long-side part of the welded portion, each having a relatively long welding length.

The present disclosure has been made in view of such circumstances, and has a purpose to provide a method for producing a power storage device, capable of reducing weld defect attributed to fumes in a first long-side part and a second long-side part.

### Means of Solving the Problems

(1) One aspect of the present disclosure provides a method for producing a power storage device that comprises: a case including a rectangular opening and an opening wall portion surrounding the opening; and a rectangular sealing plate closing the opening and including an outer periphery edge portion, the opening wall portion and the outer periphery edge portion being welded over an entire circumference, the method comprising: closing the opening of the case with the sealing plate by inserting the sealing plate in the opening; and welding by laser a to-be-welded portion of both the outer periphery edge portion of the sealing plate and the opening wall portion of the case over an entire circumference in a circumferential direction by irradiating the to-be-welded portion with a laser beam from above the sealing plate having an outer surface facing upward while the opening of the case is closed with the sealing plate, wherein the to-be-welded portion has a rectangular ring shape in a plan view, and includes a first long-side part and a second long-side part, which are parallel to each other, and a first short-side part and a second short-side part, which are parallel to each other, welding the to-be-welded portion includes: welding the first long-side part through scanning of the laser beam from a second short-side part side to a first short-side part side of the first long-side part, and welding the second long-side part through scanning of the laser beam from a first short-side part side to a second short-side part side of the second long-side part, the welding of the first long-side part is performed while generating a first gas stream that flows above the first long-side part from the first short-side part side to the second short-side part side, and the welding of the second long-side part is performed while generating a second gas stream that flows above the second long-side part from the second short-side part side to the first short-side part side.

In the above-described production method, the process of welding the first long-side part by laser is performed while generating the first gas stream to flow above the first long-side part from the first short-side part side to the second short-side part side (i.e., from one side or end of the first long-side part, close to the first short-side part, to the other side or end of the first long-side part, close to the second short-side part), e.g., in a direction opposite to a scanning direction of the laser beam. The first gas stream causes the fumes generated due to irradiation with the laser beam to move to a side where laser welding of the first long-side part has been completed, i.e., a side where irradiation with the laser beam has been completed. This can reduce the fumes present in the space above a portion of the first long-side part, which is to be irradiated with the laser beam. Thus, the laser beam traveling toward the first long-side part (specifically, a portion that is to be irradiated with the laser beam) in the space above the first long-side part is prevented from being diffused by fumes. Accordingly, energy density of the laser beam can be prevented from decreasing in the first long-side part. Specifically, the laser beam can be appropriately converged, and the first long-side part can be irradiated with the converged laser beam. Accordingly, weld defect in the first long-side part can be reduced.

Furthermore, in the above-described production method, the process of welding the second long-side part is performed while generating the second gas stream to flow above the second long-side part from the second short-side part side to the first short-side part side (i.e., from one side or end of the second long-side part, close to the second short-side part, to the other side or end of the second long-side part, close to the first short-side part), e.g., in a direction opposite to the scanning direction of the laser beam. The second gas stream causes the fumes generated due to irradiation with the laser beam to move to a side where laser welding of the second long-side part has been completed, i.e., a side where irradiation with the laser beam has been completed. In the process of welding the second long-side part, this can reduce the fumes present in the space above a portion, of the second long-side part, which is to be irradiated with the laser beam. Thus, the laser beam traveling toward the second long-side part (specifically, a portion that is to be irradiated with the laser beam) in the space above the second long-side part is prevented from diffused by fumes. Accordingly, energy density of the laser beam can be prevented from decreasing in the second long-side part. Specifically, the laser beam can be appropriately converged, and the second long-side part can be irradiated with the converged laser beam. Accordingly, weld defect in the second long-side part can be reduced.

As described above, with the above-described production method, weld defect attributed to fumes can be reduced in the first long-side part and the second long-side part of the to-be-welded portion between the sealing plate and the case, each having a relatively long welding length. Thus, weld defect between the case and the sealing plate can be effectively reduced. Here, the to-be-welded portion is a portion joining the outer periphery edge of the sealing plate and the opening wall portion of the case, which are welded with each other. This to-be-welded portion has a rectangular ring shape in a plan view, including the first long-side part and the second long-side part, which are parallel to each other, and the first short-side part and the second short-side part, which are parallel to each other. In addition, fumes are dust floating in the space, specifically, fine metal particles formed by cooling metal vapor generated from the to-be-welded portion due to welding heat.

(2) The method for producing a power storage device in (1) may be configured such that, in welding the first long-side part, a first fume generated from the first long-side part and carried by the first gas stream to pass above the first long-side part is sucked and removed by a first suction device, and in welding the second long-side part, a second fume generated from the second long-side part and carried by the second gas stream to pass above the second long-side part is sucked and removed by a second suction device.

In the above-described production method, in the process of welding the first long-side part, the first fume generated from the first long-side part (specifically, a portion irradiated with the laser beam) is blown by the first gas stream to pass above the first long-side part, and then is sucked and removed by the first suction device. Accordingly, weld defect attributed to the first fume can be further reduced in the first long-side part. Furthermore, in the process of welding the second long-side part, the second fume generated from the second long-side part (specifically, a portion irradiated with the laser beam) is blown by the second gas stream to pass above the second long-side part, and then is sucked and removed by the second suction device. Accordingly, weld defect attributed to the second fume can be further reduced in the second long-side part.

(3) The method for producing a power storage device in (1) or (2) may be configured such that welding the to-be-welded portion includes: welding the first short-side part through scanning of the laser beam from a first long-side part side to a second long-side part side of the first short-side part, and welding the second short-side part through scanning of the laser beam from a second long-side part side to a first long-side part side of the second short-side part, the welding of the first short-side part is performed while generating a third gas stream that flows above the first short-side part from the second long-side part side to the first long-side part side, and the welding of the second short-side part is performed while generating a fourth gas stream that flows above the second short-side part from the first long-side part side to the second long-side part side.

In the above-described production method, the process of welding the first short-side part is performed while generating the third gas stream to flow above the first short-side part from the second long-side part side to the first long-side part side (i.e., from one side or end of the first short-side part, close to the second long-side part, to the other side or end of the first short-side part, close to the first long-side part). The third gas stream causes the fumes generated due to irradiation with the laser beam to move to a side where laser welding of the first short-side part has been completed, i.e., a side where irradiation with the laser beam has been completed. This can reduce the fumes present in the space above a portion, of the first short-side part, which is to be irradiated with the laser beam. Thus, the laser beam traveling toward the first short-side part (specifically, a portion that is to be irradiated with the laser beam) in the space above the first short-side part is prevented from being diffused by fumes. Accordingly, energy density of the laser beam can be prevented from decreasing in the first short-side part. Specifically, the laser beam can be appropriately converged, and the first short-side part can be irradiated with the converged laser beam. Accordingly, weld defect in the first short-side part can be reduced.

Furthermore, in the above-described production method, the process of welding the second short-side part is performed while generating the fourth gas stream to flow above the second short-side part from the first long-side part side to the second long-side part side (i.e., from one side or end of the second short-side part, close to the first long-side part, to the other side or end of the second short-side part, close to the second long-side part). The fourth gas stream causes the fumes generated due to irradiation with the laser beam to move to a side where laser welding of the second short-side part has been completed, i.e., a side where irradiation with the laser beam has been completed. In the process of welding the second short-side part, this can reduce the fumes present in the space above a portion, of the second short-side part, which is to be irradiated with the laser beam. Thus, the laser beam traveling toward the second short-side part (specifically, a portion that is to be irradiated with the laser beam) in the space or air above the second short-side part is prevented from being diffused by fumes. Accordingly, energy density of the laser beam can be prevented from decreasing in the second short-side part. Specifically, the laser beam can be appropriately converged, and the second short-side part can be irradiated with the converged laser beam. Accordingly, weld defect in the second short-side part can be reduced.

As described above, with the above-described production method, weld defect attributed to fumes can be reduced not only in the first long-side part and the second long-side part but also in the first short-side part and the second short-side part. Thus, weld defect between the case and the sealing plate can be further reduced.

(4) The method for producing a power storage device in (3) may be configured such that, in welding the first short-side part, a third fume generated from the first short-side part and carried by the third gas stream to pass above the first short-side part is sucked and removed by a third suction device, and in welding the second short-side part, a fourth fume generated from the second short-side part and carried by the fourth stream to pass above the second short-side part is sucked and removed by a fourth suction device.

In the above-described production method, in the process of welding the first short-side part, the third fume generated from the first short-side part (specifically, a portion irradiated with the laser beam) is blown by the third gas stream to pass above the first short-side part, and then is sucked and removed by the third suction device. Accordingly, weld defect attributed to third fume can be further reduced in the first short-side part. Furthermore, in the process of welding the second short-side part, the fourth fume generated from the second short-side part (specifically, a portion irradiated with the laser beam) is blown by the fourth gas stream to pass above the second short-side part, and then is sucked and removed by the fourth suction device. Accordingly, weld defect attributed to the fourth fume can be further reduced in the second short-side part.

### BRIEF DESCRIPTION OF THE DRAWINGS

FIG. 1 is a plan view (a top view) of a power storage device in an embodiment;

FIG. 2 is a cross-sectional view taken along a line B-B in FIG. 1;

FIG. 3 is a plan view of a sealing plate in the embodiment;

FIG. 4 is a plan view of a case in the embodiment;

FIG. 5 is a front view of the case;

FIG. 6 is a view illustrating a closing step in the embodiment;

FIG. 7 is another view illustrating the closing step;

FIG. 8 is a cross-sectional view taken along a line C-C in FIG. 7;

FIG. 9 is a view illustrating a welding step in the embodiment;

FIG. 10 is another view illustrating the welding step;

FIG. 11 is a view illustrating a welding step in a modification; and

FIG. 12 is another view illustrating the welding step.

### DETAILED DESCRIPTION OF THE EXEMPLARY EMBODIMENTS

### Embodiment

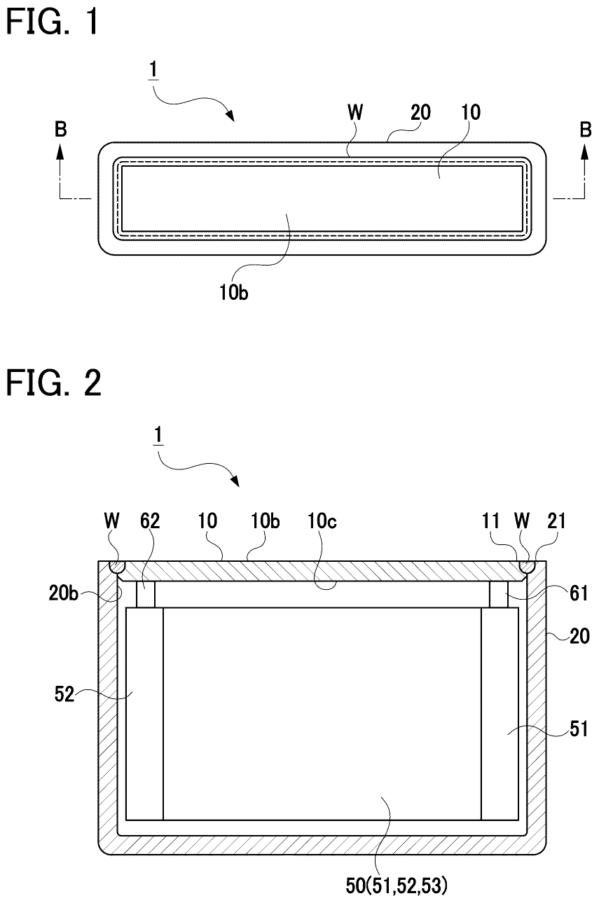

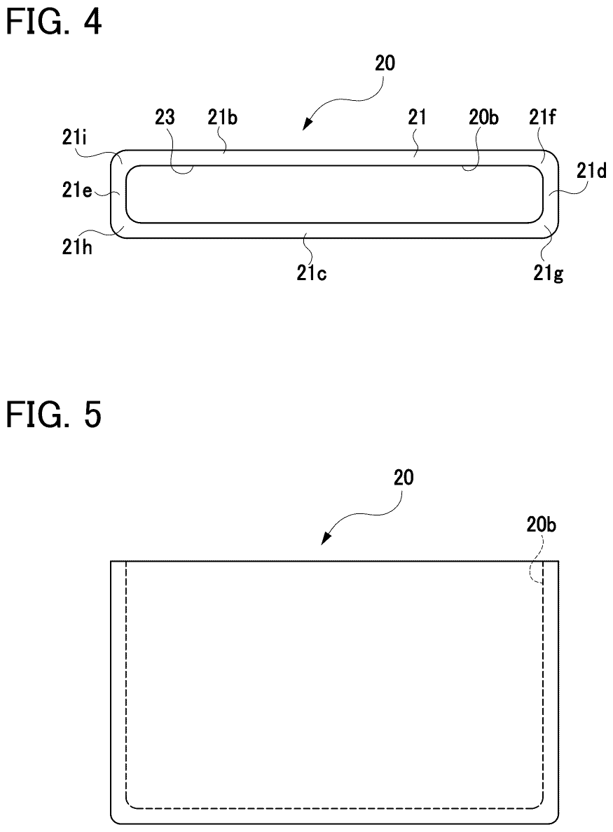

Hereinafter, an embodiment of the present disclosure will be described. A power storage device 1 of the present embodiment is a lithium-ion secondary battery. The power storage device 1 includes an electrode body 50, a case 20 housing the electrode body 50, and a sealing plate 10 closing an opening 20b of the case 20 (see FIGS. 1 and 2). The case 20 is a hard case made of metal and having a rectangular parallelepiped box-like shape, and includes the opening 20b having a rectangular shape (see FIGs. 4 and 5). The sealing plate 10 is made of metal, having a rectangular plate shape, and is inserted in the opening 20b of the case to close the opening 20b (see FIGs. 1 and 2).

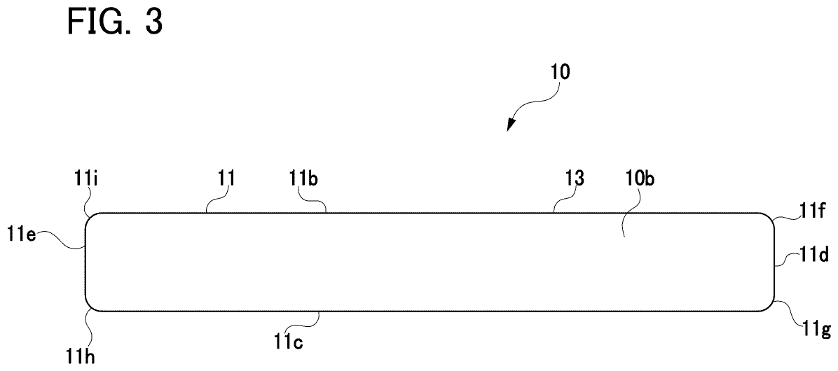

An opening wall portion 21 of the case 20 and an outer periphery edge portion 11 of the sealing plate 10 are welded to each other over the entire circumference, so that a ring-shaped welded portion W is formed (see FIGs. 1 and 2). Here, the opening wall portion 21 of the case 20 is a portion surrounding the opening 20b of the case 20, and has a rectangular ring shape in a plan view (see FIG. 4). The outer periphery edge portion 11 of the sealing plate 10 is a portion including an outer peripheral surface 13 of the sealing plate 10, and has a rectangular ring shape in a plan view (see FIG. 3).

The electrode body 50 includes a positive electrode plate 51, a negative electrode plate 52, and a separator 53 interposed between the positive electrode plate 51 and the negative electrode plate 52 (see FIG. 2). More specifically, the electrode body 50 is a flat wound electrode body in which the positive electrode plate 51 which is a strip-shaped sheet, the negative electrode plate 52 which is a strip-shaped sheet, and the separator 53 which is a strip-shaped sheet are wound together with the separator 53 interposed between the positive electrode plate 51 and the negative electrode plate 52. The electrode body 50 contains therein an electrolytic solution, which is not shown. In the case 20, the electrolytic solution, which is not shown, is also stored on a bottom side thereof.

In addition, the power storage device 1 includes a positive current collecting member 61 connected to the positive electrode plate 51 of the electrode body 50 and a negative current collecting member 62 connected to the negative electrode plate 52 of the electrode body 50 (see FIG. 2). The power storage device 1 also includes a positive terminal member (not shown) that is connected to the positive current collecting member 61 and that is exposed to the outside of the power storage device 1 through a first through hole (not shown) formed in the sealing plate 10. The power storage device 1 also includes a negative terminal member (not shown) that is connected to the negative current collecting member 62 and that is exposed to the outside of the power storage device 1 through a second through hole (not shown) formed in the sealing plate 10.

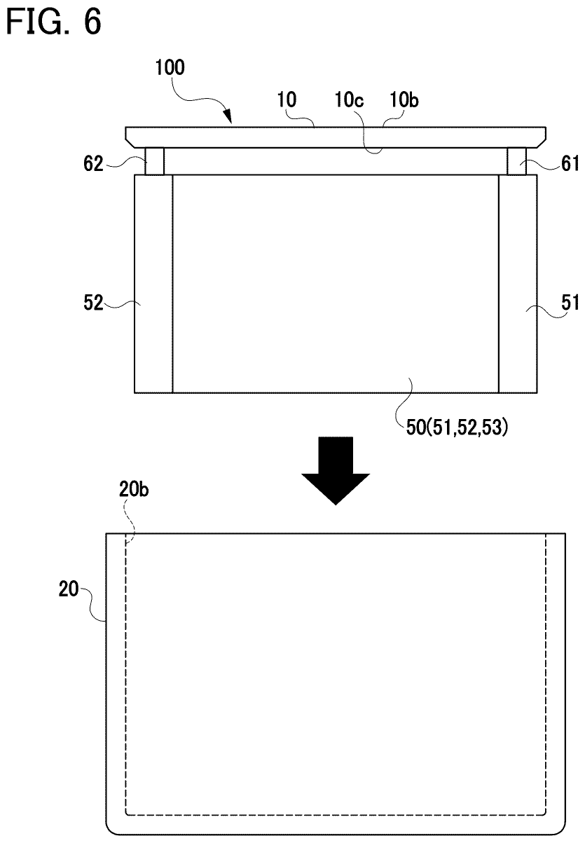

Next, a method for producing the power storage device 1 of the present embodiment will be described. First, a lid structure 100 is fabricated (see FIG. 6). Specifically, the positive current collecting member 61, the negative current collecting member 62, the positive terminal member (not shown), and the negative terminal member (not shown) are attached to the sealing plate 10, completing the lid structure 100 with these components integrated together. Next, the electrode body 50 configured as above is prepared. The positive current collecting member 61 of the lid structure 100 is connected to the positive electrode plate 51 of the electrode body 50, and the negative current collecting member 62 of the lid structure 100 is connected to the negative electrode plate 52 of the electrode body 50. Thus, the lid structure 100 and the electrode body 50 are integrated with each other (see FIG. 6).

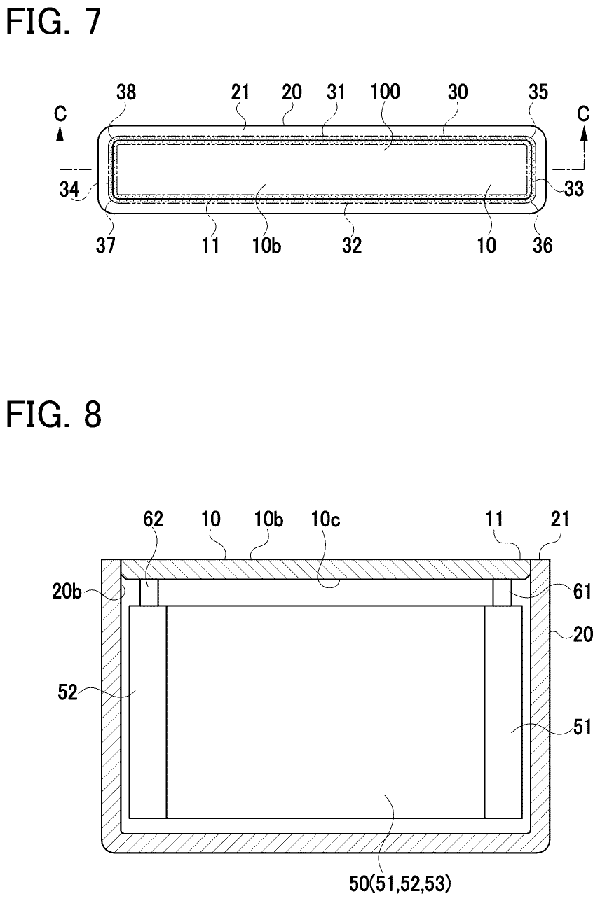

Next, in a closing step, the electrode body 50 integrated with the lid structure 100 is housed into the case 20 through the opening 20b, and the sealing plate 10 is inserted in the opening 20b of the case 20 to close the opening 20b of the case 20 with the sealing plate 10 (see FIG. 6 to FIG. 8). FIG. 7 is a plan view, or a top view, of the case 20 with the opening 20b closed with the sealing plate 10. FIG. 8 is a cross-sectional view taken along a line C-C in FIG. 7.

It is to be noted that insertion of the sealing plate 10 in the opening 20b of the case 20 is performed with a back surface 10c of the sealing plate 10 facing to the case 20. The opening wall portion 21 of the case 20, which is subjected to the closing step, has a rectangular ring shape, and includes a first opening long-side part 21b and a second opening long-side part 21c, which are parallel to each other, a first opening short-side part 21d and a second opening short-side part 21e, which are parallel to each other, and four arc-shaped opening corners 21f to 21i connecting these side parts (see FIG. 4). The opening corner 21f is a portion connecting the first opening long-side part 21b and the first opening short-side part 21d. The opening corner 21g is a portion connecting the second opening long-side part 21c and the first opening short-side part 21d. The opening corner 21h is a portion connecting the second opening long-side part 21c and the second opening short-side part 21e. The opening corner 21i is a portion connecting the first opening long-side part 21b and the second opening short-side part 21e.

The sealing plate 10, which is subjected to the closing step, has the following configuration. Specifically, the outer periphery edge portion 11 of the sealing plate 10 has a rectangular ring shape, and includes a first sealing long-side part 11b and a second sealing long-side part 11c, which are parallel to each other, a first sealing short-side part 11d and a second sealing short-side part 11e, which are parallel to each other, and four arc-shaped sealing corners 11f to 11i connecting these side parts (see FIG. 3). The sealing corner 11f is a portion connecting the first sealing long-side part 11b and the first sealing short-side part 11d. The sealing corner 11g is a portion connecting the second sealing long-side part 11c and the first sealing short-side part 11d. The sealing corner 11h is a portion connecting the second sealing long-side part 11c and the second sealing short-side part 11e. The sealing corner 11i is a portion connecting the first sealing long-side part 11b and the second sealing short-side part 11e.

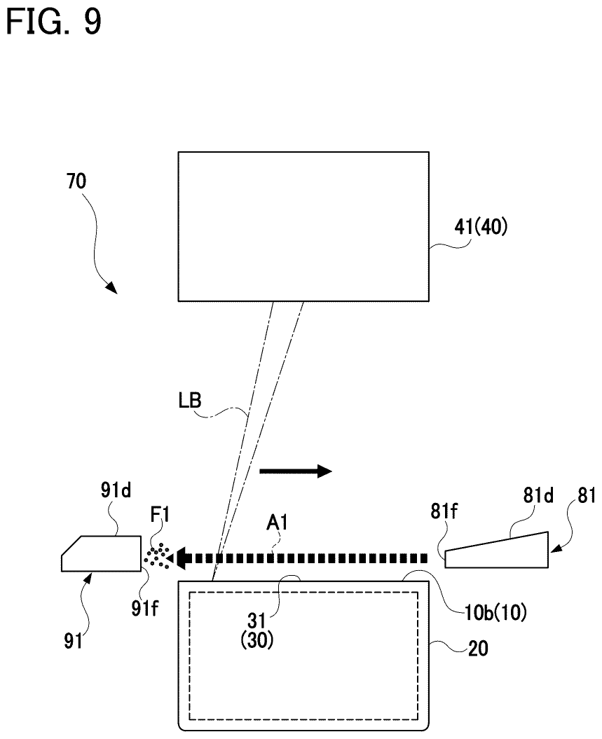

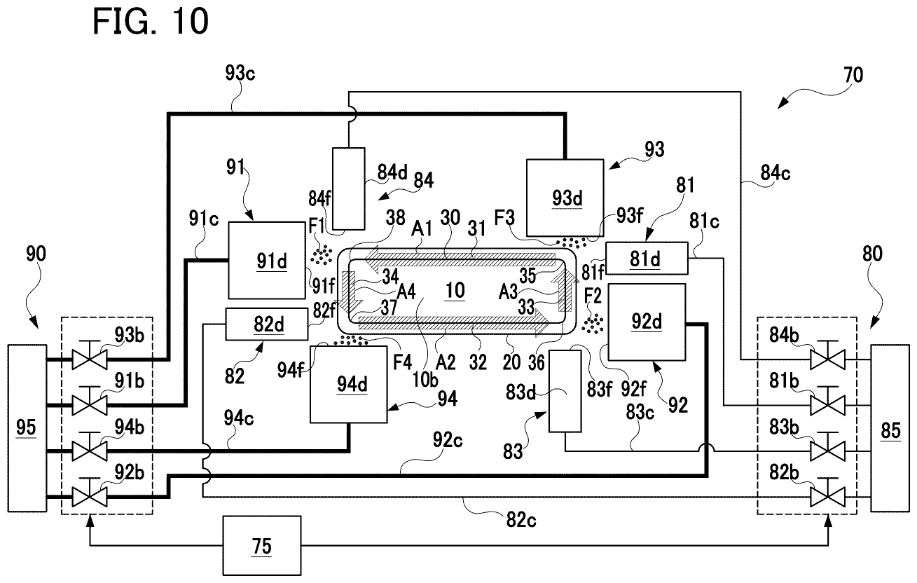

Subsequently, in a welding step, in a state where the opening 20b of the case 20 is closed with the sealing plate 10, a to-be-welded portion 30 of both the outer periphery edge portion 11 of the sealing plate 10 and the opening wall portion 21 of the case 20 is subjected to laser-welding over the entire circumference (see FIGs. 9 and 10). Specifically, this welding step is performed, with an outer surface 10b of the sealing plate 10 facing upward, by irradiating the to-be-welded portion 30 with a laser beam LB from above the sealing plate 10, to laser-welding the to-be-welded portion 30.

As shown in FIG. 7, the to-be-welded portion 30 has a rectangular ring shape in a plan view, and includes a first long-side part 31 and a second long-side part 32, which are parallel to each other, a first short-side part 33 and a second short-side part 34, which are parallel to each other, and four arc-shaped corners 35, 36, 37, 38 connecting these side parts. The first long-side part 31 is formed by the first opening long-side part 21b and the first sealing long-side part 11b. The second long-side part 32 is formed by the second opening long-side part 21c and the second sealing long-side part 11c. The first short-side part 33 is formed by the first opening short-side part 21d and the first sealing short-side part 11d. The second short-side part 34 is formed by the second opening short-side part 21e and the second sealing short-side part 11e. The corners 35 to 38 are formed by the opening corners 21f to 21i and the sealing corners 11f to 20 11i, respectively. In the present embodiment, through scanning of the laser beam LB in a circumferential direction of the to-be-welded portion 30, the to-be-welded portion 30 is laser-welded over its entire circumference (see FIGs. 9 and 10).

In the present embodiment, a welding device 70 is used to perform the welding step (see FIGs. 9 and 10). FIG. 9 is a schematic front view of the welding device 70, and shows laser welding being performed on the first long-side part 31. FIG. 10 is a schematic plan view of the welding device 70. The welding device 70 includes a laser irradiator 40, a gas delivery unit 80, a suction unit 90, and a controller 75. The laser irradiator 40 includes a welding head 41 and a laser oscillator (not shown). The welding head 41 is connected to the laser oscillator (not shown) via an optical fiber, and emits the laser beam LB transmitted from the laser oscillator, toward the to-be-welded portion 30. Specifically, the welding head 41 irradiates the to-be-welded portion 30 with the laser beam LB over the entire circumference by scanning of the laser beam LB in the circumferential direction of the to-be-welded portion 30.

The gas delivery unit 80 includes a gas delivery body 85, a first delivery device 81, a second delivery device 82, a third delivery device 83, and a fourth delivery device 84. The gas delivery body 85 is, for example, a known air compressor. The first delivery device 81 includes a first delivery part 81d having a gas delivery port 81f, and a first delivery pipe 81c provided with a first delivery valve 81b. The first delivery part 81d is connected to the gas delivery body 85 through the first delivery pipe 81c. The second delivery device 82 includes a second delivery part 82d having a gas delivery port 82f, and a second delivery pipe 82c provided with a second delivery valve 82b. The second delivery part 82d is connected to the gas delivery body 85 through the second delivery pipe 82c.

The third delivery device 83 includes a third delivery part 83d having a gas delivery port 83f, and a third delivery pipe 83c provided with a third delivery valve 83b. The third delivery part 83d is connected to the gas delivery body 85 through the third delivery pipe 83c. The fourth delivery device 84 includes a fourth delivery part 84d having a gas delivery port 84f, and a fourth delivery pipe 84c provided with a fourth delivery valve 84b. The fourth delivery part 84d is connected to the gas delivery body 85 through the fourth delivery pipe 84c. In FIG. 9, some parts of the gas delivery unit 80 and the suction unit 90 are not shown. In FIG. 10, the welding head 41 is not shown. The gas delivery port 81f of the first delivery part 81d is disposed on one side i.e., the right side in FIG. 10, of a space above the first long-side part 31, and a gas (e.g., air in the present embodiment) supplied from the gas delivery body 85 to the first delivery part 81d through the first delivery pipe 81c is delivered, i.e., ejected, toward the space above the first long-side part 31. This generates a first gas stream A1 flowing above the first long-side part 31 from the first short-side part 33 side to the second short-side part 34 side i.e., from right to left in FIGS. 9 and 10.

The gas delivery port 82f of the second delivery part 82d is disposed on the one side, i.e., the left side in FIG. 10, of a space above the second long-side part 32, and a gas (e.g., air in the present embodiment) supplied from the gas delivery body 85 to the second delivery part 82d through the second delivery pipe 82c is delivered, i.e., ejected, toward the space above the second long-side part 32. This generates a second gas stream A2 flowing above the second long-side part 32 from the second short-side part 34 side to the first short-side part 33 side, i.e., from left to right in FIG. 10.

The gas delivery port 83f of the third delivery part 83d is disposed on one side, i.e., the lower side in FIG. 10, of a space above the first short-side part 33, and a gas (e.g., air in the present embodiment) supplied from the gas delivery body 85 to the third delivery part 83d through the third delivery pipe 83c is delivered, i.e., ejected, through the gas delivery port 83f toward the space above the first short-side part 33. This generates a third gas stream A3 flowing above the first short-side part 33 from the second long-side part 32 side to the first long-side part 31 side, i.e., from bottom to top in FIG. 10.

The gas delivery port 84f of the fourth delivery part 84d is disposed on one side, i.e., the upper side in FIG. 10, of a space above the second short-side part 34, and a gas (e.g., air in the present embodiment) supplied from the gas delivery body 85 to the fourth delivery part 84d through the fourth delivery pipe 84c is delivered, i.e., ejected, through the gas delivery port 84f toward the space above the second short-side part 34. This generates a fourth gas stream A4 flowing above the second short-side part 34 from the first long-side part 31 side to the second long-side part 32 side, i.e., from top to bottom in FIG. 10.

The suction unit 90 includes a suction body 95, a first suction device 91, a second suction device 92, a third suction device 93, and a fourth suction device 94. The suction body 95 is, for example, a known dust collector. The first suction device 91 includes a first suction part 91d having a suction port 91f, and a first suction pipe 91c provided with a first suction valve 91b. The first suction part 91d is connected to the suction body 95 through the first suction pipe 91c. The second suction device 92 includes a second suction part 92d having a suction port 92f, and a second suction pipe 92c provided with a second suction valve 92b. The second suction part 92d is connected to the suction body 95 through the second suction pipe 92c.

The third suction device 93 includes a third suction part 93d having a suction port 93f, and a third suction pipe 93c provided with a third suction valve 93b. The third suction part 93d is connected to the suction body 95 through the third suction pipe 93c. The fourth suction device 94 includes a fourth suction part 94d having a suction port 94f, and a fourth suction pipe 94c provided with a fourth suction valve 94b. The fourth suction part 94d is connected to the suction body 95 through the fourth suction pipe 94c.

The suction port 91f of the first suction part 91d is disposed on the other side, i.e., the left side in FIG. 10, of the space above the first long-side part 31. Thus, the gas delivery port 81f of the first delivery part 81d and the suction port 91f of the first suction part 91d are positioned so as to face each other on both sides of the space above the first long-side part 31 in an extending direction of first long-side part 31 i.e., in a right-left direction in FIG. 10. The first suction part 91d sucks, through the suction port 91f, a first fume F1 carried by the first gas stream A1 to pass above the first long-side part 31, together with air contained in the first gas stream A1. The first fume F1 sucked by the first suction part 91d is collected in the suction body 95 via the first suction pipe 91c. Herein, fumes are dust floating in a space, or air, specifically, fine metal particles formed when metal vapor generated from the welded portion 30 due to welding heat is cooled. The first fume F1 represents fumes that are generated from the first long-side part 31 due to irradiation with the laser beam LB and floats in the space above the first long-side part 31.

The suction port 92f of the second suction part 92d is disposed on the other side, i.e., the right side in FIG. 10, of the space above the second long-side part 32. Thus, the gas delivery port 82f of the second delivery part 82d and the suction port 92f of the second suction part 92d are positioned so as to face each other on both sides of the space above the second long-side part 32 in an extending direction of the second long-side part 32, i.e., in a right-left direction in FIG. 10. The second suction part 92d sucks, through the suction port 92f, a second fume F2 carried by the second gas stream A2 to pass above the second long-side part 32, together with air contained in the second gas stream A2. The second fume F2 sucked by the second suction part 92d is collected in the suction body 95 via the second suction pipe 92c. The second fume F2 represents fumes that are generated from the second long-side part 32 due to irradiation with the laser beam LB and floats in the space above the second long-side part 32.

The suction port 93f of the third suction part 93d is disposed on the other side, i.e., the upper side in FIG. 10, of the space above the first short-side part 33. Thus, the gas delivery port 83f of the third delivery part 83d and the suction port 93f of the third suction part 93d are positioned so as to face each other on both sides of the space above the first short-side part 33 in an extending direction of the first short-side part 33, i.e., in an up-down direction in FIG. 10. The third suction part 93d sucks, through the suction port 93f, a third fume F3 carried by the third gas stream A3 to pass above the first short-side part 33, together with air contained in the third gas stream A3. The third fume F3 sucked by the third suction part 93d is collected in the suction body 95 via the third suction pipe 93c. The third fume F3 represents fumes that are generated from the first short-side part 33 due to irradiation with the laser beam LB and floats in the space above the first short-side part 33.

The suction port 94f of the fourth suction part 94d is disposed on the other side, i.e., the lower side in FIG. 10, of the space above the second short-side part 34. Thus, the gas delivery port 84f of the fourth delivery part 84d and the suction port 94f of the fourth suction part 94d are positioned so as to face each other on both sides of the space above the second short-side part 34 in an extending direction of the second short-side part 34, i.e., the up-down direction in FIG. 10. The fourth suction part 94d sucks, through the suction port 94f, a fourth fume F4 carried by the fourth gas stream A4 to pass above the second short-side part 34, together with air contained in the fourth gas stream A4. The fourth fume F4 sucked by the fourth suction part 94d is collected in the suction body 95 via the fourth suction pipe 94c. The fourth fume F4 represents fumes that are generated from the second short-side part 34 due to irradiation with the laser beam LB and floats in the space above the second short-side part 34.

According to a position to be irradiated with the laser beam LB, the controller 75 controls opening/closing of the first delivery valve 81b, the second delivery valve 82b, the third delivery valve 83b, and the fourth delivery valve 84b, and controls opening/closing of the first suction valve 91b, the second suction valve 92b, the third suction valve 93b, and the fourth suction valve 94b. Specifically, when irradiating the first long-side part 31 with the laser beam LB, the controller 75 opens the first delivery valve 81b and the first suction valve 91b and closes the other valves. When irradiating the second long-side part 32 with the laser beam LB, the controller 75 opens the second delivery valve 82b and the second suction valve 92b and closes the other valves. When irradiating the first short-side part 33 with the laser beam LB, the controller 75 opens the third delivery valve 83b and the third suction valve 93b and closes the other valves. When irradiating the second short-side part 34 with the laser beam LB, the controller 75 opens the fourth delivery valve 84b and the fourth suction valve 94b and closes the other valves.

The gas delivery port 81f of the first delivery part 81d, the gas delivery port 82f of the second delivery part 82d, the gas delivery port 83f of the third delivery part 83d, the gas delivery port 84f of the fourth delivery part 84d, the suction port 91f of the first suction part 91d, the suction port 92f of the second suction part 92d, the suction port 93f of the third suction part 93d, and the suction port 94f of the fourth suction part 94d are positioned on the same height, or level, in the up-down direction (see FIG. 9). Accordingly, the first gas stream A1, the second gas stream A2, the third gas stream A3, and the fourth gas stream A4 are gas streams traveling straight along the first long-side part 31, the second long-side part 32, the first short-side part 33, and the second short-side part 34, respectively.

Hereinafter, the welding step of the present embodiment will be described. In the present embodiment, scanning of the laser beam LB is performed on the first long-side part 31, the corner 35, the first short-side part 33, the corner 36, the second long-side part 32, the corner 37, the second short-side part 34, and the corner 38 in this order, whereby the to-be-welded portion 30 (see FIG. 7) is laser-welded over its entire circumference. First, in a step of welding the first long-side part (i.e., in a first-long-side-part welding step), using the laser irradiator 40, the first long-side part 31 is irradiated with the laser beam LB while performing scanning of the laser beam LB from the second short-side part 34 side to the first short-side part 33 side of the first long-side part 31, i.e., from left to right in FIG. 10, thereby welding the first long-side part 31.

The first-long-side-part welding step is performed while generating the first gas stream A1, through the first delivery device 81, to flow above the first long-side part 31 from the first short-side part 33 side to the second short-side part 34 side, i.e., from right to left in FIGS. 9 and 10. Specifically, the first delivery valve 81b is opened by the control of the controller 75 while the gas delivery body 85 is driven, thereby generating the first gas stream A1 from the first delivery device 81. At this time, since the second delivery valve 82b, the third delivery valve 83b, and the fourth delivery valve 84b are all closed, none of the second gas stream A2, the third gas stream A3, or the fourth gas stream A4 is formed.

Therefore, the first-long-side-part welding step is performed while generating the first gas stream A1 that travels in a direction opposite to a scanning direction of the laser beam LB. This first gas stream A1 moves, or blows away, the first fume F1 generated due to irradiation with the laser beam LB toward a side or area where the laser welding of the first long-side part 31 has been completed, i.e., a side or area where irradiation with the laser beam LB has been completed. This can reduce the first fume F1 in a space above a portion, of the first long-side part 31, which is to be irradiated with the laser beam LB. Thus, the laser beam LB emitted from the welding head 41 and traveling toward the first long-side part 31 is prevented from colliding with the first fume F1 and being diffused thereby. Accordingly, energy density of the laser beam LB can be prevented from decreasing in the first long-side part 31. Specifically, the laser beam LB can be appropriately converged, and the first long-side part 31 can be irradiated with the converged laser beam LB. Accordingly, weld defect in the first long-side part 31 can be reduced.

Furthermore, in the first-long-side-part welding step, during welding of the first long-side part 31, the first fume F1 generated from the first long-side part 31 is carried by the first gas stream A1 to pass above the first long-side part 31 and then is sucked and removed by the first suction device 91. Specifically, the first suction valve 91b is opened by the control of the controller 75 while the suction body 95 is driven, thereby sucking the first fume F1 through the first suction device 91. At this time, the second suction valve 92b, the third suction valve 93b, and the fourth suction valve 94b are all closed. As described above, the first fume F1 is sucked and removed by the first suction device 91, so that weld defect attributed to the first fume F1 can be further reduced in the first long-side part 31.

Subsequently, the corner 35 is laser-welded by using the laser irradiator 40, and then a step of welding the first short-side part (i.e., a first-short-side-part welding step) follows. The first short-side part 33 is irradiated and welded with the laser beam LB by scanning of the laser beam LB from the first long-side part 31 side to the second long-side part 32 side of the first short-side part 33, i.e., from top to bottom in FIG. 10.

The first-short-side-part welding step is performed while generating the third gas stream A3, through the third delivery device 83, to flow above the first short-side part 33 from the second long-side part 32 side to the first long-side part 31 side, i.e., from bottom to top in FIG. 10. Specifically, the third delivery valve 83b is opened by the control of the controller 75 while the gas delivery body 85 is driven, thereby generating the third gas stream A3 from the third delivery device 83. At this time, since the first delivery valve 81b, the second delivery valve 82b, and the fourth delivery valve 84b are all closed, none of the first gas stream A1, the second gas stream A2, or the fourth gas stream A4 is formed.

Therefore, the first-short-side-part welding step is performed while generating the third gas stream A3 that travels in a direction opposite to the scanning direction of the laser beam LB. This third gas stream A3 moves, or blows away, the third fume F3 generated due to irradiation with the laser beam LB toward a side or area where laser welding of the first short-side part 33 has been completed, i.e., a side or area where irradiation with the laser beam LB has been completed. This can reduce the third fume F3 in a space above a portion, of the first short-side part 33, which is to be irradiated with the laser beam LB. Thus, the laser beam LB emitted from the welding head 41 and traveling toward the first short-side part 33 is prevented from colliding with the third fume F3 and being diffused thereby. Accordingly, energy density of the laser beam LB can be prevented from decreasing in the first short-side part 33. Specifically, the laser beam LB can be appropriately converged, and the first short-side part 33 can be irradiated with the converged laser beam LB. Accordingly, weld defect in the first short-side part 33 can be reduced.

Furthermore, in the first-short-side-part welding step, during welding of the first short-side part 33, the third fume F3 generated from the first short-side part 33 is carried by the third gas stream A3 to pass above the first short-side part 33, and then is sucked and removed by the third suction device 93. Specifically, the third suction valve 93b is opened by the control of the controller 75 while the suction body 95 is driven, thereby sucking the third fume F3 through the third suction device 93. At this time, the first suction valve 91b, the second suction valve 92b, and the fourth suction valve 94b are all closed. As described above, the third fume F3 is sucked and removed by the third suction device 93, so that weld defect attributed to the third fume F3 can be further reduced in the first short-side part 33.

Subsequently, the corner 36 is laser-welded by using the laser irradiator 40, and then a step of welding the second long-side part (i.e., a second-long-side-part welding step) follows. The second long-side part 32 is irradiated and welded with the laser beam LB by scanning of the laser beam LB from the first short-side part 33 side to the second short-side part 34 side of the second long-side part 32, i.e., from right to left in FIG. 10.

The second-long-side-part welding step is performed while generating the second gas stream A2, through the second delivery device 82, to flow above the second long-side part 32 from the second short-side part 34 side to the first short-side part 33 side, i.e., from left to right in FIG. 10. Specifically, the second delivery valve 82b is opened by the control of the controller 75 while the gas delivery body 85 is driven, thereby generating the second air flow A2 from the second delivery device 82. At this time, since the first delivery valve 81b, the third delivery valve 83b, and the fourth delivery valve 84b are all closed, none of the first gas stream A1, the third gas stream A3, or the fourth gas stream A4 is formed.

Therefore, the second-long-side-part welding step is performed while generating the second gas stream A2 that travels in a direction opposite to the scanning direction of the laser beam LB. This second gas stream A2 moves, or blows away, the second fume F2 generated due to irradiation with the laser beam LB toward a side or area where laser welding of the second long-side part 32 has been completed, i.e., a side or area where irradiation with the laser beam LB has been completed. This can reduce the second fume F in a space above a portion, in the second long-side part 32, which is to be irradiated with the laser beam LB. Thus, the laser beam LB emitted from the welding head 41 and traveling toward the second long-side part 32 is prevented from colliding with the second fume F2 and being diffused thereby. Accordingly, energy density of the laser beam LB can be prevented from decreasing in the second long-side part 32. Specifically, the laser beam LB can be appropriately converged, and the second long-side part 32 can be irradiated with the converged laser beam LB. Accordingly, weld defect in the second long-side part 32 can be reduced.

Furthermore, in the second-long-side-part welding step, during welding of the second long-side part 32, the second fume F2 generated from the second long-side part 32 is carried by the second gas stream A2 to pass above the second long-side part 32, and then is sucked and removed by the second suction device 92. Specifically, the second suction valve 92b is opened by the control of the controller 75 while the suction body 95 is driven, thereby sucking the second fume F2 through the second suction device 92. At this time, the first suction valve 91b, the third suction valve 93b, and the fourth suction valve 94b are all closed. As described above, the second fume F2 is sucked and removed by the second suction device 92, so that weld defect attributed to the second fume F2 can be further reduced in the second long-side part 32.

Subsequently, the corner 37 is laser-welded by using the laser irradiator 40, and then a step of welding the second short-side part (i.e., a second-short-side-part welding step) follows. The second short-side part 34 is irradiated and welded with the laser beam LB by scanning of the laser beam LB from the second long-side part 32 side to the first long-side part 31 side of the second short-side part 34, i.e., from bottom to top in FIG. 10).

The second-short-side-part welding step is performed while generating the fourth gas stream A4, through the fourth delivery device 84 to flow above the second short-side part 34 from the first long-side part 31 side to the second long-side part 32 side, i.e., from top to bottom in FIG. 10. Specifically, the fourth delivery valve 84b is opened by the control of the controller 75 while the gas delivery body 85 is driven, thereby generating the fourth air flow A4 from the fourth delivery device 84. At this time, since the first delivery valve 81b, the second delivery valve 82b, and the third delivery valve 83b are all closed, none of the first gas stream A1, the second gas stream A2, or the third gas stream A3 is formed.

Therefore, the second-short-side-part welding step is performed while generating the fourth gas stream A4 that travels in a direction opposite to the scanning direction of the laser beam LB. This fourth gas stream A4 moves, or blows away, the fourth fume F4 generated due to irradiation with the laser beam LB toward a side or area where laser welding of the second short-side part 34 has been completed, i.e., a side or area where irradiation with the laser beam LB has been completed. This can reduce the fourth fume F4 in a space above a portion, in the second short-side part 34, which is to be irradiated with the laser beam LB. Thus, the laser beam LB emitted from the welding head 41 and traveling toward the second short-side part 34 is prevented from colliding with the fourth fume F4 and being diffused thereby. Accordingly, energy density of the laser beam LB can be prevented from decreasing in the second short-side part 34. Specifically, the laser beam LB can be appropriately converged, and the second short-side part 34 can be irradiated with the converged laser beam LB. Accordingly, weld defect in the second short-side part 34 can be reduced.

Furthermore, in the second-short-side-part welding step, during welding of the second short-side part 34, the fourth fume F4 generated from the second short-side part 34 is carried by the fourth gas stream A4 to pass above the second short-side part 34, and then is sucked and removed by the fourth suction device 94. Specifically, the fourth suction valve 94b is opened by the control of the controller 75 while the suction body 95 is driven, thereby sucking the fourth fume F4 through the fourth suction device 94. At this time, the first suction valve 91b, the second suction valve 92b, and the third suction valve 93b are all closed. As described above, the fourth fume F4 is sucked and removed by the fourth suction device 94, so that weld defect attributed to the fourth fume F4 can be further reduced in the second short-side part 34.

Subsequently, the corner 38 is welded, and thus the to-be-welded portion 30 is laser-welded over its entire circumference. Accordingly, the welding step is completed, and the case 20 and the sealing plate 10 are integrally joined. Then, the electrolytic solution (not shown) is injected into the case 20 through a liquid inlet (not shown) formed in the sealing plate 10. Then, the liquid inlet is sealed to complete the power storage device 1.

### MODIFIED EXAMPLES

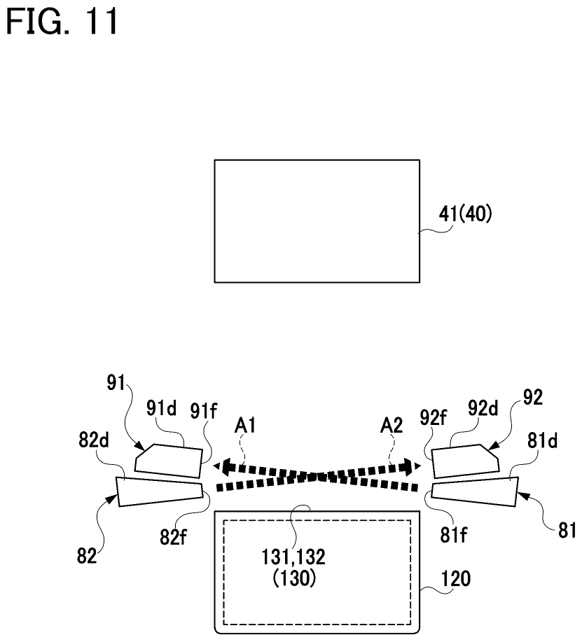

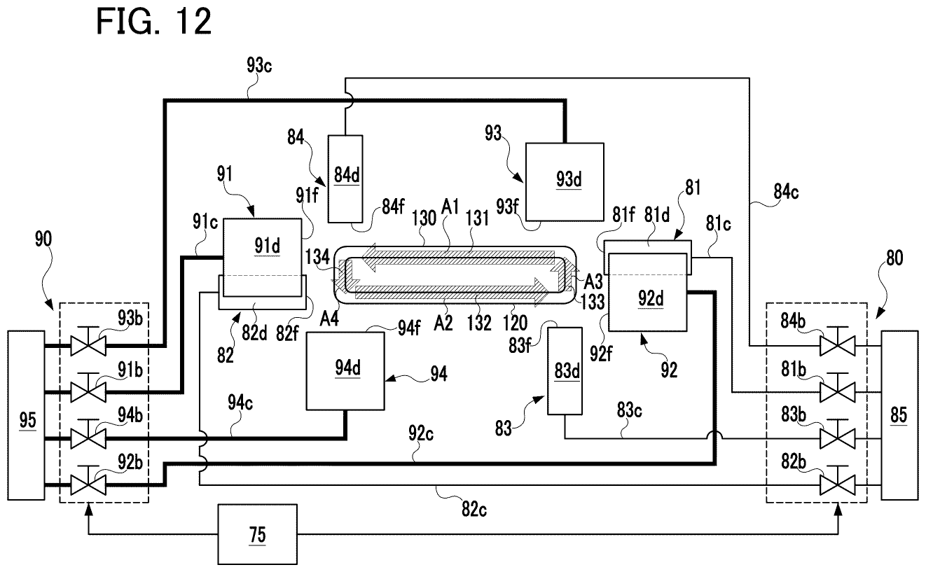

Next, a modification of the present disclosure will be described. In the present modification, a case 120 has a thin thickness, a distance between a first long-side part 131 and a second long-side part 132 of a to-be-welded portion 130 (i.e., a distance in a thickness direction of the case 120) is small, and thus it is difficult to arrange the first delivery part 81d and the second suction part 92d of the welding device 70 side by side, and to arrange the second delivery part 82d and the first suction part 91d of the welding device 70 side by side, in the thickness direction of the case 120, i.e., an up-down direction in FIG. 12. In such a case, as shown in FIG. 11, the first delivery part 81d and the second suction part 92d may be arranged overlapping one on the other in the up-down direction. Accordingly, the first delivery part 81d can be disposed on the first side (the right side in FIG. 12) of the space above the first long-side part 131, and the second suction part 92d can be disposed on the first side (the right side in FIG. 12) of the space above the second long-side part 132. Furthermore, the second delivery part 82d and the first suction part 91d may be arranged overlapping one on the other in the up-down direction. Accordingly, the second delivery part 82d can be disposed on the second side (the left side in FIG. 12) of the space above the second long-side part 132, and the first suction part 91d can be disposed on the second side (the left side in FIG. 12) of the space above the first long-side part 131.

Accordingly, in a welding step, a first gas stream A1 that flows above the first long-side part 131 from a first short-side part 133 side to a second short-side part 134 side, i.e., from one side to the other side of the first long-side part 131, can be appropriately generated from the first delivery part 81d, and a second fume F2 carried above the second long-side part 132 by a second gas stream A2 can be appropriately sucked by the second suction part 92d. Furthermore, the second gas stream A2 that flows above the second long-side part 132 from the second short-side part 134 side to the first short-side part 133 side, i.e., from one side to the other side of the second long-side part 132, can be appropriately formed by the second delivery part 82d, and a first fume F1 carried above the first long-side part 131 by the first gas stream A1 can be appropriately sucked by the first suction part 91d.

As shown in FIG. 11, the gas delivery port 81f of the first delivery part 81d and the gas delivery port 82f of the second delivery part 82d may be positioned on the same height, or level, in the up-down direction, and a suction port 91f of the first suction part 91d and a suction port 92f of the second suction part 92d may be positioned on the same height, or level, in the up-down direction. Accordingly, the position of the first gas stream A1 in the up-down direction with respect to the first long-side part 131 and the position of the second gas stream A2 in the up-down direction with respect to the second long-side part 132 can be almost the same in height. Accordingly, in the welding step, the first fume F1, which is sucked and removed together with the first gas stream A1 by the first suction part 91d, and the second fume F2, which is sucked and removed together with the second gas stream A2 by the second suction part 92d, can be substantially equal in degree.

While the present disclosure has been described above based on the embodiment and the modified embodiment, it should be understood that the present disclosure is not limited thereto but can be applied with modifications appropriately made thereto without departing from the scope of the gist of the present disclosure.

### REFERENTIAL SIGN LIST

1 Power storage device
10 Sealing plate
11 Outer periphery edge portion
20 Case
20b Opening
21 Opening wall portion
30 To-be-welded portion
31 First long-side part
32 Second long-side part
33 First short-side part
34 Second short-side part
40 Laser irradiator
50 Electrode body
70 Welding device
80 Gas delivery unit
90 Suction unit
91 First suction unit
92 Second suction unit
93 Third suction unit
94 Fourth suction unit
A1 First gas stream
A2 Second gas stream
A3 Third gas stream
A4 Fourth gas stream
LB Laser beam
W Welded portion

What is claimed is:

1. A method for producing a power storage device that comprises:
a case including a rectangular opening and an opening wall portion surrounding the opening; and
a rectangular sealing plate closing the opening and including an outer periphery edge portion,
the opening wall portion and the outer periphery edge portion being welded over an entire circumference,
the method comprising:
closing the opening of the case with the sealing plate by inserting the sealing plate in the opening; and
welding by laser a to-be-welded portion of both the outer periphery edge portion of the sealing plate and the opening wall portion of the case over an entire circumference in a circumferential direction by irradiating the to-be-welded portion with a laser beam from above the sealing plate having an outer surface facing upward while the opening of the case is closed with the sealing plate,
wherein
the to-be-welded portion has a rectangular ring shape in a plan view, and includes a first long-side part and a second long-side part, which are parallel to each other, and a first short-side part and a second short-side part, which are parallel to each other,
welding the to-be-welded portion includes:
welding the first long-side part through scanning of the laser beam from a second short-side part side to a first short-side part side of the first long-side part, and
welding the second long-side part through scanning of the laser beam from a first short-side part side to a second short-side part side of the second long-side part,
the welding of the first long-side part is performed while generating a first gas stream that flows above the first long-side part from the first short-side part side to the second short-side part side, and
the welding of the second long-side part is performed while generating a second gas stream that flows above the second long-side part from the second short-side part side to the first short-side part side.

2. The method for producing a power storage device according to claim 1, wherein
in welding the first long-side part, a first fume generated from the first long-side part and carried by the first gas stream to pass above the first long-side part is sucked and removed by a first suction device, and
in welding the second long-side part, a second fume generated from the second long-side part and carried by the second gas stream to pass above the second long-side part is sucked and removed by a second suction device.

3. The method for producing a power storage device according to claim 1, wherein
welding the to-be-welded portion includes:
welding the first short-side part through scanning of the laser beam from a first long-side part side to a second long-side part side of the first short-side part, and
welding the second short-side part through scanning of the laser beam from a second long-side part side to a first long-side part side of the second short-side part,
the welding of the first short-side part is performed while generating a third gas stream that flows above the first short-side part from the second long-side part side to the first long-side part side, and
the welding of the second short-side part is performed while generating a fourth gas stream that flows above the second short-side part from the first long-side part side to the second long-side part side.

4. The method for producing a power storage device according to claim 2, wherein
welding the to-be-welded portion includes:
welding the first short-side part through scanning of the laser beam from a first long-side part side to a second long-side part side of the first short-side part, and
welding the second short-side part through scanning of the laser beam from a second long-side part side to a first long-side part side of the second short-side part,
the welding of the first short-side part is performed while generating a third gas stream that flows above the first short-side part from the second long-side part side to the first long-side part side, and
the welding of the second short-side part is performed while generating a fourth gas stream that flows above the second short-side part from the first long-side part side to the second long-side part side.

5. The method for producing a power storage device according to claim 3, wherein
in welding the first short-side part, a third fume generated from the first short-side part and carried by the third gas stream to pass above the first short-side part is sucked and removed by a third suction device, and
in welding the second short-side part, a fourth fume generated from the second short-side part and carried by the fourth stream to pass above the second short-side part is sucked and removed by a fourth suction device.

6. The method for producing a power storage device according to claim 4, wherein
in welding the first short-side part, a third fume generated from the first short-side part and carried by the third gas stream to pass above the first short-side part is sucked and removed by a third suction device, and
in welding the second short-side part, a fourth fume generated from the second short-side part and carried by the fourth stream to pass above the second short-side part is sucked and removed by a fourth suction device.
